(19) United States
(12) Patent Application Publication
(10) Pub. No.: US 2025/0135507 A1
(43) Pub. Date: May 1, 2025

(54) HIGH-PRESSURE CLEANING DEVICE

(71) Applicants: Jung Mo KIM, Busan (KR); KT&G CORPORATION, Daejeon (KR)

(72) Inventors: Jung Mo KIM, Busan (KR); Jae Seok LEE, Daejeon (KR)

(73) Assignees: Jung Mo KIM, Busan (KR); KT&G CORPORATION, Daejeon (KR)

(21) Appl. No.: 18/834,910

(22) PCT Filed: Mar. 30, 2023
(86) PCT No.: PCT/KR2023/004243

§ 371 Date: Jul. 31, 2024

(30) Foreign Application Priority Data
Mar. 30, 2022 (KR) 10-2022-0039311
Mar. 24, 2023 (KR) 10-2023-0038718

(51) Int. Cl. B08B 3/02; B05B 3/02; B08B 3/14; B08B 9/00

(52) U.S. Cl. CPC B08B 3/024; B05B 3/02; B08B 3/14; B08B 9/00; B08B 2203/007; B08B 2203/0211

(57) ABSTRACT

This high-pressure cleaning device comprises: a main body; a cover covering the upper portion of the main body; a cleaning tank formed between the main body and the cover; and a cleaning assembly disposed in the cleaning tank, wherein the cleaning assembly comprises a base in which an object to be cleaned is disposed and a first cleaning module for cleaning the object to be cleaned. The first cleaning module comprises: a cleaning liquid supply pipe; a rotating disc comprising a first surface that is perpendicular to the lengthwise direction of the cleaning liquid supply pipe, a second surface formed at the opposite side to the first surface, and a side surface formed between the first surface and the second surface; a plurality of cleaning nozzles formed in parallel to the rotary shaft of the rotating disc; and a plurality of propulsion nozzles formed to be inclined with respect to the rotary shaft of the rotating disc, wherein the rotating disc can be rotated due to the injection from the propulsion nozzles.

### TECHNICAL FIELD

The following embodiments relate to a high-pressure cleaning device.

### BACKGROUND ART

In general, cigarette machines and packaging machines for low ignition propensity (LIP) coating units, which frequently use adhesives in industrial settings, utilize the adhesive supply nozzles of the adhesive application device to supply glue-type adhesives, thereby adhesively packaging objects to be packaged. In particular, a packaging machine of a cigarette machine is prone to contamination from various substances scattering during the process of applying adhesive to wrap a cigarette in a wrapper, and thus, regular cleaning is necessary. In particular, because adhesives have strong adhesive properties and solidify over time, simply impregnating the packaging machine in a cleaning liquid is not enough to keep the packaging machine clean. Therefore, cleaning requires using a powerful spray of cleaning liquid.

Conventionally, the adhesive stuck to a packaging machine is softened by continuously supplying hot water, and then the packaging machine is cleaned manually by workers. This method results in high consumption of cleaning liquid (cleaning water), requires a lot of cleaning time, and leads to significant energy waste due to the use of gas for heating the water.

The packaging machine is a bowl-shaped unit with a recessed interior. Because of this unique shape, manually cleaning the adhesive stuck inside has been challenging.

### DISCLOSURE OF THE INVENTION

### Technical Goals

An embodiment provides a high-pressure cleaning device that reduces contamination and other issues caused by solidified adhesives by cleaning parts to which adhesive materials are applied at regular intervals.

An embodiment provides a high-pressure cleaning device that filters a cleaning liquid sucked from a water tank in a filtration device and then circulates the cleaning liquid as a cleaning liquid, thereby reducing the waste of the cleaning liquid by allowing the water in the water tank to be used repeatedly.

### Technical Solutions

A high-pressure cleaning device according to various embodiments includes a main body, a cover configured to cover an upper portion of the main body, a cleaning tank formed between the main body and the cover, and a cleaning assembly disposed in the cleaning tank, wherein the cleaning assembly includes a base in which an object to be cleaned is disposed and a first cleaning module configured to clean the object to be cleaned, wherein the first cleaning module includes a cleaning liquid supply pipe, a rotating disk including a first surface perpendicular to a longitudinal direction of the cleaning liquid supply pipe, a second surface formed on a side opposite to the first surface, and a side surface formed between the first surface and the second surface, a plurality of cleaning nozzles formed in parallel to a rotation shaft of the rotating disk, and a plurality of propulsion nozzles formed to be inclined with respect to the rotation shaft of the rotating disk, and wherein the rotating disk is rotated due to spraying from the propulsion nozzle.

In an embodiment, the plurality of cleaning nozzles may extend in a direction perpendicular to the second surface of the rotating disk.

In an embodiment, the plurality of propulsion nozzles may be disposed on the side surface of the rotating disk and formed to be inclined with respect to the rotation shaft of the rotating disk.

In an embodiment, angles formed between the plurality of propulsion nozzles and the first surface may be adjustable.

In an embodiment, the high-pressure cleaning device may further include a second cleaning module, wherein the second cleaning module includes a spray stem extending upward in the cleaning tank and through which a cleaning liquid moves, a spray branch extending outward from the spray stem, and a spray nozzle disposed at an end of the spray branch.

In an embodiment, the spray branch may extend in a direction traversing a longitudinal direction of the spray stem, and the spray nozzle may face the object to be cleaned.

In an embodiment, the first cleaning module may further include a cleaning liquid receiving chamber formed in the rotating disk, and the plurality of cleaning nozzles and the plurality of propulsion nozzles communicate with the cleaning liquid receiving chamber.

In an embodiment, the high-pressure cleaning device may further include a water reservoir formed on a bottom of the cleaning tank, wherein a cleaning liquid that cleans the object to be cleaned may be returned to the water reservoir, filtered, and reused.

In an embodiment, the high-pressure cleaning device may further include a water cleaning module disposed in the water reservoir, wherein the water cleaning module may include an inlet port formed at a height corresponding to a water surface level of a cleaning liquid stored in the water reservoir and a discharge port configured to discharge floating matter introduced into the inlet port to outside.

In an embodiment, the high-pressure cleaning device may further include a circulation port in fluid communication with the water reservoir, wherein the circulation port may be configured to transport, to a filter device, the cleaning liquid returned to the water reservoir.

In an embodiment, the high-pressure cleaning device may further include a heater disposed in the water reservoir and configured to heat the cleaning liquid.

In an embodiment, at least a portion of a cleaning liquid sprayed from the cleaning nozzle and the propulsion nozzle may be sprayed toward a recess of the object to be cleaned.

In an embodiment, the high-pressure cleaning device may further include a jig configured to fix the object to be cleaned to the base, wherein the jig may be in contact with an inner wall of the recess of the object to be cleaned.

A high-pressure cleaning device according to various embodiments includes a main body, a cover configured to cover the main body, a cleaning tank formed between the main body and the cover, and a cleaning assembly disposed in the cleaning tank, wherein the cleaning assembly includes a base in which an object to be cleaned is disposed and a first cleaning module configured to clean the object to be cleaned, wherein the first cleaning module includes a cleaning liquid supply pipe, a rotating disk including a first surface perpendicular to a longitudinal direction of the cleaning liquid supply pipe, a second surface formed on a side opposite to the first surface, and a side surface formed between the first surface and the second surface, and a plurality of spray nozzles extending from the rotating disk, and wherein at least a portion of the spray nozzle sprays a cleaning liquid toward the object to be cleaned in a direction perpendicular to the second surface of the rotating disk.

### Effects of the Invention

A high-pressure cleaning device according to an embodiment may reduce contamination and other issues caused by solidified adhesives by cleaning parts to which adhesive materials are applied at regular intervals.

The high-pressure cleaning device according to an embodiment may filter a cleaning liquid sucked from a water tank in a filtration device and then circulate it as a cleaning liquid, thereby reducing the waste of the cleaning liquid by allowing the water in the water tank to be used repeatedly.

The effects of the high-pressure cleaning device according to an embodiment are not limited to the above-mentioned effects, and other unmentioned effects can be clearly understood from the above description by those having ordinary skill in the technical field to which the present disclosure pertains.

### BRIEF DESCRIPTION OF DRAWINGS

FIG. 1 is a schematic perspective view of a high-pressure cleaning device according to an embodiment.

FIG. 2 is a schematic rear view of the high-pressure cleaning device according to an embodiment.

FIG. 3 is a schematic cross-sectional view of the high-pressure cleaning device of FIG. 1 taken along line 3-3′, according to an embodiment.

FIG. 4 is an enlarged view of a cleaning tank of the high-pressure cleaning device of FIG. 3, according to an embodiment.

FIG. 5 is a schematic cross-sectional view of a first cleaning module according to an embodiment.

FIG. 6 is a schematic view illustrating a rotation mechanism of the first cleaning module, according to an embodiment.

### BEST MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, or c” should be construed as including a, b, c, a and b, a and c, b and c, or a, b, and c.

In the following embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In the following embodiments, “upward” or “upper” refers to a direction (e.g., +Z direction in the drawing) away from a bottom surface or a portion located in that direction, and “downward” or “lower” refers to a direction (e.g., −Z direction in the drawing) toward the bottom surface or a portion located in that direction. The terms “upper” and “lower” may be used to describe relative positions of components of a high-pressure cleaning device.

An embodiment may be implemented in the form of a recording medium including instructions executable by a computer, such as a program module executable by the computer. A computer-readable medium may be any available medium that can be accessed by a computer and includes all of a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

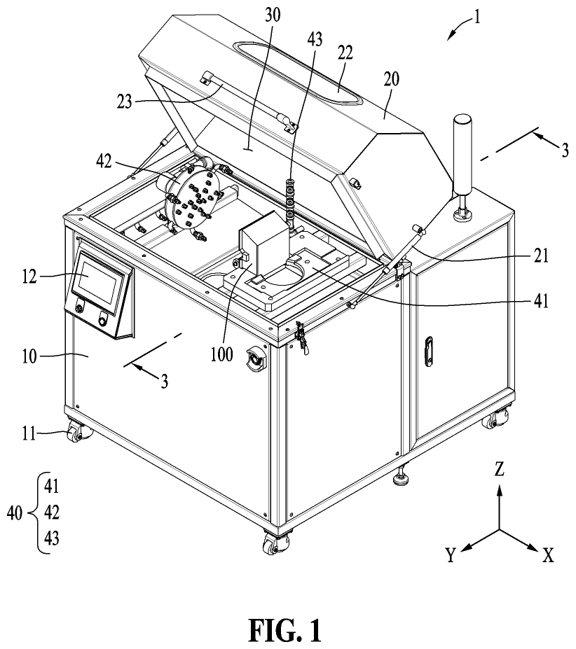

FIG. 1 is a schematic perspective view of a high-pressure cleaning device 1, according to an embodiment.

Referring to FIG. 1, the high-pressure cleaning device 1 may include a main body 10, a cover 20, a cleaning tank 30, and a cleaning assembly 40.

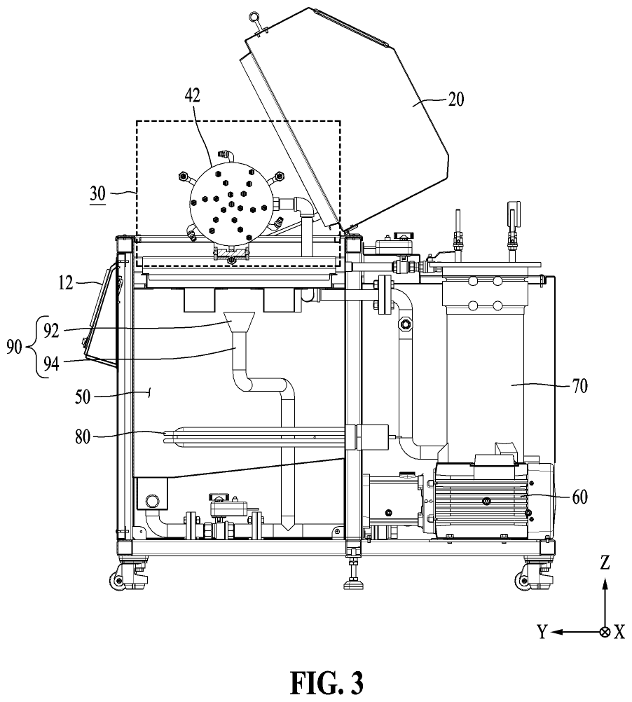

In an embodiment, the main body 10 may be formed of a sturdy material to protect some components included in the high-pressure cleaning device 1. The main body 10 according to an embodiment may be formed in a hexahedral shape. The main body 10 may include a water reservoir (e.g., a water reservoir 50 of FIG. 3). The main body 10 according to an embodiment may include a wheel 11 on the bottom. The wheel 11 may facilitate the movement of the heavy high-pressure cleaning device 1. The main body 10 according to an embodiment may include a screen 12. The screen 12 may display the operational status and monitoring control alarms of the high-pressure cleaning device 1, such as cleaning liquid pressure, cleaning liquid temperature, filter pressure, cleaning time, water level control, and the number of cleaning liquid replacements. The screen 12 may include a touch panel, so a user may control the operational status through the touch panel.

In an embodiment, the cover 20 may be disposed to cover the upper portion of the main body 10. The cover 20 may be hinged to the upper portion of the main body 10 and may open and close. A side surface of the cover 20 may be connected to the main body 10 by a cylinder 21. The cylinder 21 may be driven hydraulically or pneumatically. In an embodiment, the cover 20 may further include a window 22. The window 22 may be formed of a transparent or translucent material such as glass, acrylic, or the like. The user may easily check the cleaning status inside the cleaning tank 30 through the window 22. In an embodiment, the cover 20 may further include a handle 23. The user may easily open and close the cover 20 by holding the handle 23.

In an embodiment, the cleaning tank 30 may include a space formed between the main body 10 and the cover 20. The cleaning tank 30 may be a space in which an object to be cleaned 100 is actually cleaned. In an embodiment, the object to be cleaned 100 may be a bowl-shaped unit that extends to one side from the bottom, forming a recess. The object to be cleaned 100 may include a cigarette packaging machine, a Blueband packaging machine, a drum, and the like used in the manufacturing process of tobacco, particularly cigarettes.

The cleaning assembly 40 may be disposed in the cleaning tank 30. Although not shown, two or more cleaning assemblies 40 may be disposed in the cleaning tank 30. The cleaning tank 30 may further include a drainage hole (not shown) in the bottom surface of the cleaning tank 30. A cleaning liquid sprayed onto the object to be cleaned 100 by the cleaning assembly 40 may return to the water reservoir (e.g., the water reservoir 50 of FIG. 3) in the main body through a drainage hole.

In an embodiment, the cleaning assembly 40 may include a base 41, a first cleaning module 42, and a second cleaning module 43. The base 41 may be formed so that the object to be cleaned 100 is disposed therein.

The base 41 may be disposed on one side of the bottom surface (e.g., the bottom surface on the +X side in FIG. 1) of the cleaning tank 30. The base 41 may be formed to have an engraved shape corresponding to the outer shape of the object to be cleaned 100, so that the object to be cleaned 100 may be stably fixed.

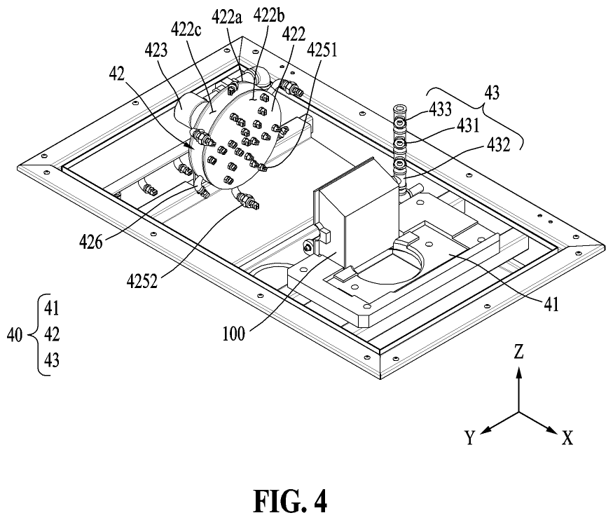

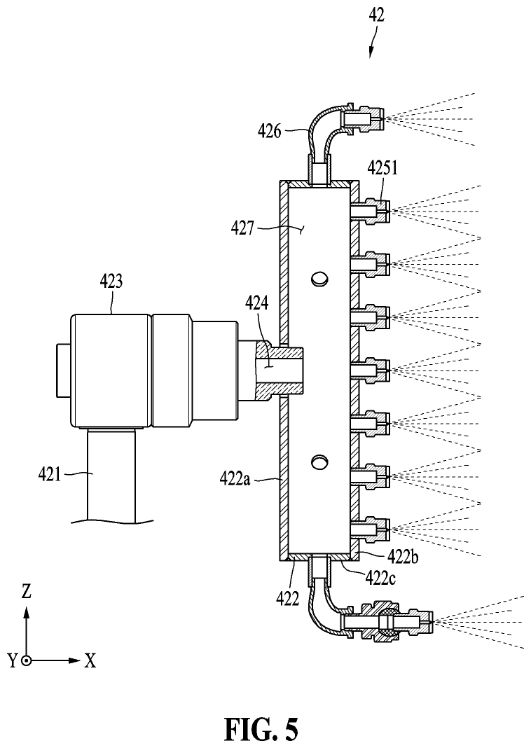

The first cleaning module 42 may be disposed on the bottom surface (e.g., the bottom surface on the −X side in FIG. 1) opposite to the base 41. The first cleaning module 42 may spray a high-pressure cleaning liquid onto the object to be cleaned 100 fixed to the base 41. The first cleaning module 42 may spray a high-pressure cleaning liquid while rotating on a plane perpendicular to the spraying direction with respect to the object to be cleaned 100. In an embodiment, the first cleaning module 42 may rotate by electric power. In another embodiment, the first cleaning module 42 may rotate according to the action-reaction effect caused by the cleaning liquid sprayed from a propulsion nozzle (e.g., a propulsion nozzle 426 of FIG. 5). The components and driving method of the first cleaning module 42 are described in more detail below with reference to FIGS. 4 and 5.

The second cleaning module 43 may be formed to extend upward (e.g., +Z direction in FIG. 1) from the bottom surface adjacent to the base 41. The second cleaning module 43 may spray a cleaning liquid toward the object to be cleaned 100 together with the first cleaning module 42. The components and driving method of the second cleaning module 43 are described in more detail below with reference to FIGS. 4 and 5.

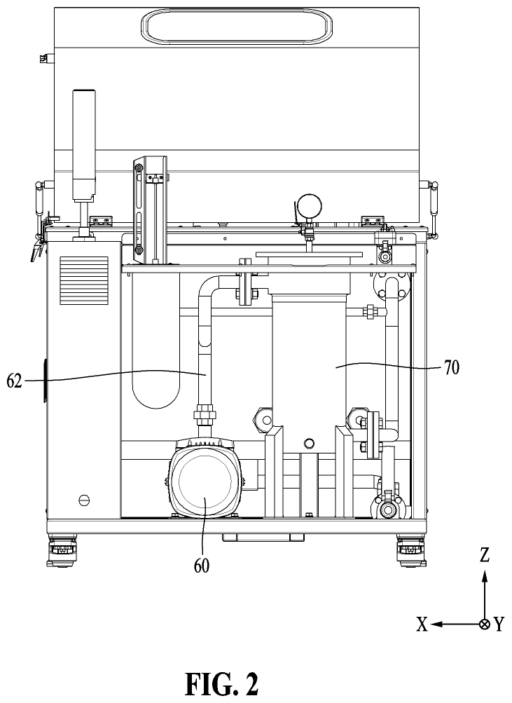

FIG. 2 is a schematic rear view of the high-pressure cleaning device 1 according to an embodiment.

Referring to FIG. 2, the high-pressure cleaning device 1 may further include a pump 60 and a filter device 70.

In an embodiment, the pump 60 may suck a cleaning liquid from a water reservoir (e.g., the water reservoir 50 of FIG. 3) through a circulation port 62 and transport the cleaning liquid to the filter device 70. The cleaning liquid filtered by the filter device 70 may be supplied to the water reservoir 50 through the circulation port 62. The pump 60 may supply the cleaning liquid purified by the filter device 70 back to the cleaning assembly 40.

In an embodiment, the filter device 70 may filter a cleaning liquid used to clean an object to be cleaned (e.g., the object to be cleaned 100 of FIG. 1) in a cleaning tank (e.g., the cleaning tank 30 of FIG. 1). The cleaning liquid filtered by the filter device 70 may be sprayed back onto the cleaning tank 30 through the cleaning assembly 40. The filter device 70 may include at least one filtering element, such as a filter screen, a sedimentation filter, an activated carbon filter, an osmotic pressure filter, and a high efficiency particulate air (HEPA) filter. A filtering element included in the filter device 70 according to an embodiment may be replaced after being used approximately 1,000 times.

In an embodiment, the cleaning liquid may be repeatedly reused while circulating through the water reservoir 50 and the filter device 70 by the pump 60. In this case, the number of repeated uses of the cleaning liquid may be determined depending on the type and shape of a glue part. For example, when a drum-shaped object to be cleaned 100 is cleaned, the cleaning liquid may be reused approximately 100 times.

FIG. 3 is a schematic cross-sectional view of the high-pressure cleaning device 1 of FIG. 1 taken along line 3-3′, according to an embodiment. Referring to FIG. 3, the high-pressure cleaning device 1 according to an embodiment may further include the water reservoir 50, a heater 80, and a water cleaning module 90.

In an embodiment, the water reservoir 50 may be formed on the bottom of the cleaning tank 30. The water reservoir 50 may store the cleaning liquid supplied to the cleaning module 42. The heater 80 may be disposed in an inner space of the water reservoir 50. The heater 80 may be an electrically operated heater. The heater 80 may heat the cleaning liquid. The heater 80 may further include a temperature sensor (not shown), and the temperature sensor may detect the temperature of the cleaning liquid inside the water reservoir 50 to ensure a constant temperature is maintained. In an embodiment, the water reservoir 50 may be partitioned from other components (e.g., the pump 60, the filter device 70, etc.) of the high-pressure cleaning device 1. Since the water reservoir 50 is a space for storing a cleaning liquid, it is desirable that electronic components sensitive to water or foreign substances are placed away from the water reservoir 50. In an embodiment, the cleaning liquid sprayed by the cleaning module 44 may clean the object to be cleaned 100, and the contaminated cleaning liquid resulting from cleaning the object to be cleaned 100 may be returned to the water reservoir 50. The contaminated cleaning liquid in the water reservoir 50 may be moved to the filter device 70 and filtered.

Continuously referring to FIG. 3, the water cleaning module 90 may be disposed in the water reservoir 50. The water cleaning module 90 may include an inlet port 92 and a discharge port 94. The height of the inlet port 92 may be positioned to correspond to the water surface level of the cleaning liquid stored in the water reservoir 50. As the cleaning liquid used for cleaning the object to be cleaned 100 falls from the cleaning tank 30 to the water reservoir 50 due to gravity, waves may be formed on the surface of the cleaning liquid stored in the water reservoir 50. Due to the waves of the cleaning liquid, floating matters may overflow into the inlet port 92 of the water cleaning module 90. The floating matters (e.g., glue product residue, foreign substances, etc.) introduced into the inlet port 92 may move along the discharge port 94 connected to the inlet port 92 and may be discharged to the outside of a high-pressure cleaning device (e.g., the high-pressure cleaning device 1 of FIG. 1). In an embodiment, the water cleaning module 90 may operate automatically at predetermined time intervals. In an embodiment, the water cleaning module 90 may operate only when the object to be cleaned 100 is not coupled to a jig (not shown) of a base (e.g., the base 41 of FIG. 1). The cycle, duration, and the like of the automatic operation of the water cleaning module 90 may be viewed and controlled through a screen (e.g., the screen 12 of FIG. 1) of the high-pressure cleaning device (e.g., the high-pressure cleaning device 1 of FIG. 1).

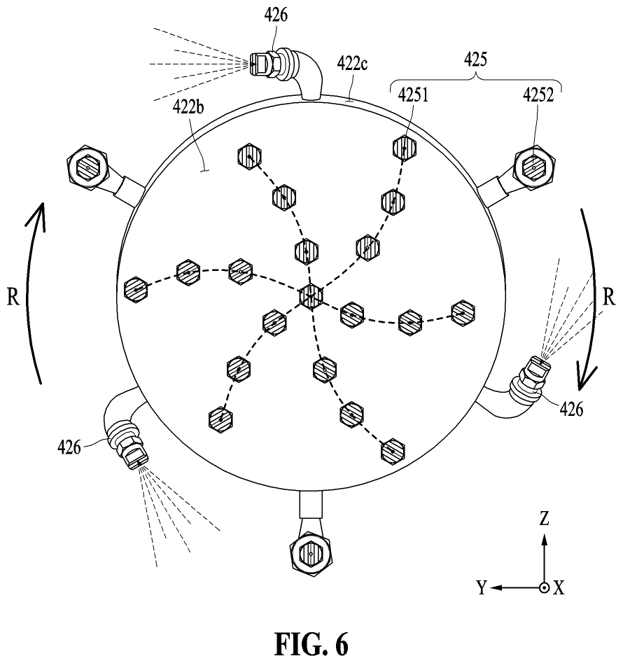

FIG. 4 is an enlarged view of the cleaning tank 30 of the high-pressure cleaning device 1 of FIG. 3, according to an embodiment. FIG. 5 is a schematic cross-sectional view of the first cleaning module 42, according to an embodiment. FIG. 6 is a schematic view illustrating a rotation mechanism of the first cleaning module 42, according to an embodiment.

Referring to FIGS. 4 to 6, the first cleaning module 42 may include a cleaning liquid supply pipe 421, a rotating disk 422, a rotary joint 423, a rotating pipe 424, a cleaning nozzle 425, a propulsion nozzle 426, and a cleaning liquid receiving chamber 427. In an embodiment, the cleaning liquid supply pipe 421 may include a conduit for transferring a cleaning liquid in a water reservoir (e.g., the water reservoir 50 of FIG. 3). The cleaning liquid supply pipe 421 may transfer the cleaning liquid filtered by a filter device (e.g., the filter device 70 of FIG. 3) to the cleaning liquid receiving chamber 427 in the rotating disk 422.

In an embodiment, the rotating disk 422 may be in fluid communication with the cleaning liquid supply pipe 421 and may include a circular cross-section perpendicular to the longitudinal direction of the cleaning liquid supply pipe 421. For example, the rotating disk 422 may include a first surface 422a in contact with the cleaning liquid supply pipe 421, a second surface 422b formed on a side opposite to the first surface 422a, and a side surface 422c formed between the first surface 422a and the second surface 422b and formed to surround the edges of the first surface 422a and the second surface 422b. The rotating disk 422 may rotate on a plane perpendicular to the cleaning liquid supply pipe 421. The rotation shaft of the rotating disk 422 may be formed parallel to the longitudinal direction of the cleaning liquid supply pipe 421. The rotating disk 422 may include a space (e.g., the cleaning liquid receiving chamber 427 of FIG. 5) for storing a cleaning liquid therein.

In an embodiment, the rotary joint 423 may serve as a joint so that the rotating disk 422 may easily rotate with respect to the cleaning liquid supply pipe 421. For example, the rotary joint 423 may include a bearing (not shown) therein. For example, the bearing included in the rotary joint 423 may include a ball bearing, a roller bearing, an oil bearing, and the like.

In an embodiment, the rotating pipe 424 may include a path through which the cleaning liquid is transferred to the rotating disk 422. The rotating pipe 424 may enable the rotating disk 422 to be in fluid communication with the rotary joint 423. The rotating pipe 424 may be formed parallel to the bottom surface on which a base (e.g., the base 41 of FIG. 1) is disposed. For example, the rotating pipe 424 may transfer the cleaning liquid in the direction parallel to the bottom surface.

In an embodiment, the cleaning nozzle 425 may be formed in the direction (e.g., +X direction in FIGS. 4 and 5) parallel to the rotation axis of the rotating disk 422. For example, the cleaning nozzle 425 may spray a cleaning liquid in the direction parallel to the rotation axis of the rotating disk 422. The cleaning nozzle 425 may include a first cleaning nozzle 4251 and a second cleaning nozzle 4252. The first cleaning nozzle 4251 may be disposed on the second surface 422b of the rotating disk 422 and may extend in the direction (e.g., +X direction in FIGS. 4 and 5) perpendicular to the second surface 422b. Since the first cleaning nozzle 4251 sprays the cleaning liquid in the same direction as the moving direction of the cleaning liquid transferred through the rotating pipe 424, the spray pressure of the cleaning liquid may be higher than that of the second cleaning nozzle 4252. A plurality of first cleaning nozzles 4251 may form a predetermined pattern and be disposed on the second surface 422b of the rotating disk 422. For example, a plurality of first cleaning nozzles 4251 may be disposed on the second surface 422b of the rotating disk 422 in a pinwheel pattern that is convex in the rotation direction of the rotating disk 422.

The second cleaning nozzle 4252 may be disposed on the side surface 422c of the rotating disk 422, may extend in the direction perpendicular to the side surface 422c (e.g., +/−Z direction in FIGS. 4 and 5), and may be bent in the direction parallel to the side surface 422c (e.g., +X direction in FIGS. 4 and 5). For example, the second cleaning nozzle 4252 may spray the cleaning liquid in the same direction as the first cleaning nozzle 4251 (e.g., +X direction in FIGS. 4 and 5).

In an embodiment, the propulsion nozzle 426 may be formed to be inclined with respect to the rotation axis of the rotating disk 422. In another embodiment, the propulsion nozzle 426 may be formed in the direction perpendicular to the rotation axis of the rotating disk 422. The propulsion nozzle 426 may be formed on the side surface 422c of the rotating disk 422. As the cleaning liquid is discharged at high pressure through the propulsion nozzle 426, the action-reaction effect caused by the rotating propulsion nozzle 426, which is attached at a predetermined angle, exerts force on the rotating disk 422 in the direction (e.g., the direction of arrow R in FIG. 6) opposite to the discharge of the cleaning liquid from the propulsion nozzle 426. Consequently, the rotating disk 422 rotates. In other words, when the cleaning liquid is sprayed toward the object to be cleaned 100 from the first cleaning module 42, the cleaning liquid with strong spray pressure rotates and is sprayed from the plurality of cleaning nozzles 425 disposed on the rotating disk 422 in communication with the cleaning liquid receiving chamber 427. This ensures that the entire surface of the object to be cleaned 100 is cleaned thoroughly. For example, instead of spraying the cleaning liquid at a predetermined position while the cleaning nozzle 425 is stationary, the cleaning liquid may be sprayed while the rotating disk 422 rotates due to the rotational force of the fluid. In particular, a plurality of cleaning nozzles 425 grouped together may spray the cleaning liquid simultaneously, thoroughly cleaning the entire surface of the object to be cleaned 100 and removing foreign substances without missing any spots, thereby enhancing the cleaning effect. In an embodiment, the propulsion nozzle 426 may be formed in plurality. The propulsion nozzles 426 may be disposed at predetermined intervals on the side surface 422c of the rotating disk 422. The angle between the propulsion nozzle 426 and the first surface 422a of the rotating disk 422 is adjustable. The rotational force transmitted to the rotating disk 422 by the propulsion nozzle 426 may vary depending on the angle between the propulsion nozzle 426 and the first surface 422a. Accordingly, the rotation velocity of the rotating disk 422 may be adjusted. For example, the closer the angle between the propulsion nozzle 426 and the first surface 422a is to 0 degrees, the faster the rotating disk 422 rotates, while the closer the angle between the propulsion nozzle 426 and the first surface 422a is to 90 degrees, the slower the rotating disk 422 rotates.

In an embodiment, the cleaning liquid receiving chamber 427 may be a space inside the rotating disk 422 to accommodate the cleaning liquid. The cleaning liquid stored in the cleaning liquid receiving chamber 427 may be sprayed to the outside through the cleaning nozzle 425 or the propulsion nozzle 426.

At least a portion of the cleaning liquid sprayed from the cleaning nozzle 425 and the propulsion nozzle 426 of the first cleaning module 42 according to an embodiment may be sprayed toward the object to be cleaned 100. More particularly, the cleaning liquid sprayed from the cleaning nozzle 425 and the propulsion nozzle 426 of the first cleaning module 42 is sprayed toward a recess of the object to be cleaned 100, thereby intensively cleaning the internal recess of the object to be cleaned 100 contaminated with adhesives and the like.

Continuously referring to FIG. 4, the cleaning assembly 40 may further include the second cleaning module 43. The second cleaning module 43 may include a spray stem 431, a spray branch 432, and a spray nozzle 433. The spray stem 431 may extend upward (e.g., +Z direction of FIG. 4) in a cleaning tank (e.g., the cleaning tank 30 of FIG. 3) and may include a path along which the cleaning liquid in the water reservoir 50 moves. The spray branch 432 may be formed to extend outward from the spray stem 431 and may include a path for moving the cleaning liquid from the spray stem 431 to the spray nozzle 433. The spray branch 432 may extend in the direction traversing the longitudinal direction of the spray stem 431. For example, the spray branch 432 may be disposed in the direction (e.g., +/−Y direction or +/−X direction of FIG. 4) perpendicular to the longitudinal direction (e.g., +Z direction of FIG. 4) of the spray stem 431, the spray nozzle 433 may be disposed at an end of the spray branch 432, and a cleaning liquid may be sprayed toward the object to be cleaned 100. The second cleaning module 43 may be disposed together with the first cleaning module 42 to remove contamination from the object to be cleaned 100.

The cleaning assembly 40 may further include a jig (not shown) for fixing the object to be cleaned 100 to the base 41, and the jig may be in contact with the inner wall of the recess of the object to be cleaned 100 to fix the object to be cleaned 100 to the base 41.

Hereinafter, a method of operating the high-pressure cleaning device 1 according to an embodiment is described as an example with reference to FIGS. 1 to 6. The high-pressure cleaning device 1 may start operating when the cover 20 is closed after the object to be cleaned 100 is attached to the base 41. The pump 60 according to an embodiment may pull the cleaning liquid stored in the water reservoir 50 and transport the cleaning liquid to the cleaning assembly 40. The cleaning liquid transported to the cleaning assembly 40 may be sprayed onto the object to be cleaned 100 by the first cleaning module 42 and the second cleaning module 43. While the cleaning liquid is sprayed onto the object to be cleaned 100, the first cleaning module 42 may rotate around one axis in the opposite direction of the high-pressure liquid sprayed from the propulsion nozzle 426 to easily clean the entire surface of the object to be cleaned 100. The cleaning liquid used to clean the object to be cleaned 100 may fall downward due to gravity and return to the water reservoir 50. The cleaning liquid returned to the water reservoir 50 may contain glue residue and other contaminants, and these contaminants may be self-cleaned by being discharged to the outside of the high-pressure cleaning device 1 by the water cleaning module 90. The cleaning liquid in the water reservoir 50 may be moved to the filter device 70 by the pump 60, filtered, and then transported to the cleaning assembly 40. Through the above series of processes, the high-pressure cleaning device 1 using a reusable cleaning liquid may operate. The series of operations of the high-pressure cleaning device 1 may be controlled by a user through a touch panel included in the screen 12 according to FIG. 1.

Although the embodiments have been described with reference to the limited drawings, one of ordinary skill in the art may apply various technical modifications and variations based thereon. Suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents of the claims are within the scope of the following claims.

1. A high-pressure cleaning device comprising:
a main body;
a cover configured to cover an upper portion of the main body;
a cleaning tank formed between the main body and the cover; and
a cleaning assembly disposed in the cleaning tank,
wherein the cleaning assembly comprises a base in which an object to be cleaned is disposed and a first cleaning module configured to clean the object to be cleaned,
wherein the first cleaning module comprises:
a cleaning liquid supply pipe;
a rotating disk comprising a first surface perpendicular to a longitudinal direction of the cleaning liquid supply pipe, a second surface formed on a side opposite to the first surface, and a side surface formed between the first surface and the second surface;
a plurality of cleaning nozzles formed in parallel to a rotation shaft of the rotating disk; and
a plurality of propulsion nozzles formed to be inclined with respect to the rotation shaft of the rotating disk, and
wherein the rotating disk is rotated due to spraying from the plurality of propulsion nozzles.

2. The high-pressure cleaning device of claim 1, wherein the plurality of cleaning nozzles extends in a direction perpendicular to the second surface of the rotating disk.

3. The high-pressure cleaning device of claim 1, wherein the plurality of propulsion nozzles is disposed on the side surface of the rotating disk and formed to be inclined with respect to the rotation shaft of the rotating disk.

4. The high-pressure cleaning device of claim 3, wherein angles formed between the plurality of propulsion nozzles and the first surface are adjustable.

5. The high-pressure cleaning device of claim 1, further comprising:
a second cleaning module,
wherein the second cleaning module comprises:
a spray stem extending upward in the cleaning tank and through which a cleaning liquid moves;
a spray branch extending outward from the spray stem; and
a spray nozzle disposed at an end of the spray branch.

6. The high-pressure cleaning device of claim 5, wherein
the spray branch extends in a direction traversing a longitudinal direction of the spray stem, and
the spray nozzle faces the object to be cleaned.

7. The high-pressure cleaning device of claim 1, wherein
the first cleaning module further comprises a cleaning liquid receiving chamber formed in the rotating disk, and
the plurality of cleaning nozzles and the plurality of propulsion nozzles communicate with the cleaning liquid receiving chamber.

8. The high-pressure cleaning device of claim 1, further comprising:
a water reservoir formed on a bottom of the cleaning tank,
wherein a cleaning liquid that cleans the object to be cleaned is returned to the water reservoir, is filtered, and reused.

9. The high-pressure cleaning device of claim 8, further comprising:
a water cleaning module disposed in the water reservoir,
wherein the water cleaning module comprises an inlet port formed at a height corresponding to a water surface level of a cleaning liquid stored in the water reservoir and a discharge port configured to discharge floating matter introduced into the inlet port to outside.

10. The high-pressure cleaning device of claim 9, further comprising:
a circulation port in fluid communication with the water reservoir,
wherein the circulation port is configured to transport, to a filter device, the cleaning liquid returned to the water reservoir.

11. The high-pressure cleaning device of claim 8, further comprising:
a heater disposed in the water reservoir and configured to heat the cleaning liquid.

12. The high-pressure cleaning device of claim 1, wherein at least a portion of a cleaning liquid sprayed from the plurality of cleaning nozzles and the plurality of propulsion nozzles is sprayed toward a recess of the object to be cleaned.

13. The high-pressure cleaning device of claim 12, further comprising:
a jig configured to fix the object to be cleaned to the base,
wherein the jig is in contact with an inner wall of the recess of the object to be cleaned.

14. A high-pressure cleaning device comprising:
a main body;
a cover configured to cover the main body;
a cleaning tank formed between the main body and the cover; and
a cleaning assembly disposed in the cleaning tank,
wherein the cleaning assembly comprises a base in which an object to be cleaned is disposed and a first cleaning module configured to clean the object to be cleaned, wherein the first cleaning module comprises:
a cleaning liquid supply pipe;
a rotating disk comprising a first surface perpendicular to a longitudinal direction of the cleaning liquid supply pipe, a second surface formed on a side opposite to the first surface, and a side surface formed between the first surface and the second surface; and
a plurality of spray nozzles extending from the rotating disk, and
wherein at least a portion of the spray nozzle sprays a cleaning liquid toward the object to be cleaned in a direction perpendicular to the second surface of the rotating disk.
